(19) United States
(12) Patent Application Publication
(10) Pub. No.: US 2026/0235188 A1
(43) Pub. Date: Aug. 13, 2026

(54) Wheel Weight Applicator Assemblies

(71) Applicant: Android Industries LLC, Auburn Hills, MI (US)

(72) Inventors: Joshua J. Hicks, Grand Blanc, MI (US); John E. Donnay, West Bloomfield, MI (US); Kerry Verran, Davison, MI (US); Anthony W. Pierce, Owosso, MI (US); Christopher M. Bulliner, Flushing, MI (US)

(21) Appl. No.: 19/466,662

(22) Filed: Feb. 2, 2026

Related U.S. Application Data
(60) Provisional application No. 63/752,944, filed on Feb. 3, 2025.

(51) Int. Cl. F16F 15/34

(52) U.S. Cl. CPC F16F 15/345; F16F 2226/04

(57) ABSTRACT

A wheel weight applicator assembly includes a base, a striking member, and a wheel weight holder. The striking member is translatably coupled to the base. The wheel weight holder is translatably coupled to the base and configured to releasably hold a wheel weight. The wheel weight holder is configured to translate relative to the base and the striking member upon engagement of the striking member with the wheel weight holder.

### CROSS-REFERENCE TO RELATED APPLICATIONS

This application claims the benefit of U.S. Provisional Application No. 63/752,944 filed Feb. 3, 2025, the entire disclosure of which is incorporated herein by reference

### FIELD

The present disclosure relates to assemblies for coupling weights to wheels.

### BACKGROUND

Balancing a vehicle's wheel is crucial for ensuring smooth and stable driving performance. When a wheel is imbalanced, it can cause vibrations, uneven tire wear, and strain on suspension components, leading to premature vehicle damage and reduced safety. Coupling one or more weights to the wheel helps distribute weight evenly, correcting imbalances and improving ride quality. Proper wheel balancing also enhances fuel efficiency, reduces maintenance costs, and prolongs the lifespan of both the tires and the vehicle's mechanical components.

Currently, coupling weights to wheels is typically accomplished manually. For example, a worker may use a hammer to attach a weight to a wheel. This manual process can be time-consuming and physically demanding, leading to inefficiencies and increasing the risk of worker fatigue or injury. While known methods for coupling weights to wheels have proven acceptable for their intended purpose, a continuous need for improvement remains in the art.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A wheel weight applicator assembly includes a base, a striking member, and a wheel weight holder. The striking member is translatably coupled to the base. The wheel weight holder is translatably coupled to the base and configured to releasably hold a wheel weight. The wheel weight holder is configured to translate relative to the base and the striking member upon engagement of the striking member with the wheel weight holder.

A wheel weight applicator assembly includes a base, a striking member, and a wheel weight holder. The striking member is translatably coupled to the base. The wheel weight holder is rotatably coupled to the base and configured to releasably hold a wheel weight. The wheel weight holder is configured to rotate relative to the base and the striking member upon engagement of the striking member with the wheel weight holder.

A wheel weight holder includes a base and an applicator rotatably coupled to the base. The applicator is configured to (i) releasably hold a wheel weight and (ii) couple the wheel weight to a wheel when the applicator is rotated relative to the base.

A wheel weight applicator includes a bracket, a first handle, a second handle, and an actuator. The first handle is coupled to the bracket and includes a first sensor. The second handle is coupled to the bracket and includes a second sensor. The actuator is coupled to the bracket and disposed between the first and second handles. The actuator is configured to be activated when the first and second sensors detect user hands on the first and second handles.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of an example wheel weight applicator assembly coupled to a robot in accordance with the principles of the present disclosure.

FIGS. 2 and 3 are additional perspective views of the wheel weight applicator assembly in accordance with the principles of the present disclosure.

FIG. 4 is a perspective view of an example wheel weight in accordance with the principles of the present disclosure.

FIG. 5 is a perspective view of an example wheel weight holder of a wheel weight applicator assembly in accordance with the principles of the present disclosure.

FIG. 6 is an exploded view of the wheel weight holder of FIG. 5.

FIGS. 7 and 8 are bottom perspective views of the wheel weight holder in accordance with the principles of the present disclosure.

FIG. 9 is an exploded view of an example actuator of a wheel weight applicator assembly in accordance with the principles of the present disclosure.

FIGS. 10 and 11 are perspective views depicting example operations of the wheel weight applicator assembly in accordance with the principles of the present disclosure.

FIG. 12 is a perspective view of an example wheel weight applicator assembly in accordance with the principles of the present disclosure.

FIG. 13 is an exploded view of an example wheel weight holder of a wheel weight applicator assembly in accordance with the principles of the present disclosure.

FIGS. 14 and 15 are bottom perspective views of the wheel weight holder in accordance with the principles of the present disclosure.

FIGS. 16 and 17 are cross-sectional views of the wheel weight holder in accordance with the principles of the present disclosure.

FIG. 18 is a perspective view depicting example operations of the wheel weight applicator assembly in accordance with the principles of the present disclosure.

FIG. 19 is a cross-sectional view depicting example operations of a wheel weight applicator assembly in accordance with the principles of the present disclosure.

FIG. 20 is a perspective view of an example wheel weight applicator in accordance with the principles of the present disclosure.

FIG. 21 is an exploded view of the wheel weight applicator of FIG. 20.

FIG. 22 is a cross-sectional view of the wheel weight applicator of FIG. 20.

In the drawings, reference numbers may be reused to identify similar and/or identical elements.

### DETAILED DESCRIPTION

### Introduction

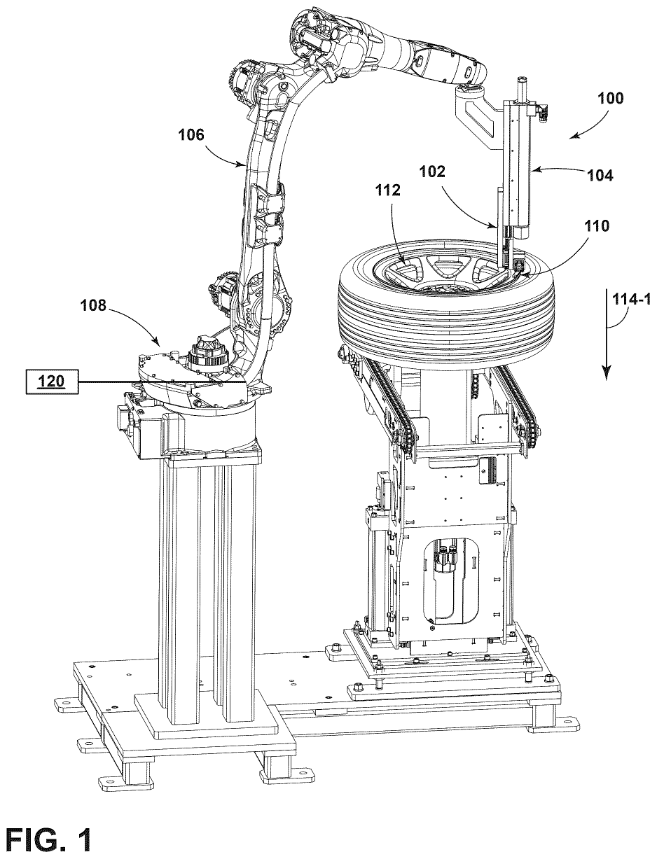

With reference to FIGS. 1-3, an example wheel weight applicator assembly 100 is shown. As will be explained in more detail below, the assembly 100 may include a wheel weight holder 102 and an actuator 104, among others. The holder 102 may be coupled to the actuator 104. The actuator 104 may be coupled to an arm 106 of a robot 108.

In various implementations, the holder 102 releasably holds a wheel weight 110. The arm 106 may move the assembly 100 so that the weight 110 is positioned adjacent a determined connection location of a wheel 112. When the actuator 104 is activated, the actuator 104 engages the holder 102, causing the weight 110 to be moved in a first direction 114-1 so that the weight 110 can be coupled to the wheel 112 at the connection location.

In various implementations, a controller 120 is communicatively coupled to the assembly 100 and/or the robot 108. The controller 120 may include an electronic controller and/or an electronic processor, such as a programmable microprocessor and/or microcontroller. The controller 120 may include an application specific integrated circuit (ASIC). The controller 120 may include a central processing unit (CPU), a memory (for example, a non-transitory computer-readable storage medium), and/or an input/output (I/O) interface. The controller 120 may perform various functions, including those described in greater detail herein, with appropriate programming instructions and/or code embodied in software, hardware, and/or other medium. The controller 120 may include a plurality of controllers. The controller 120 may be connected to a display, such as a touch screen.

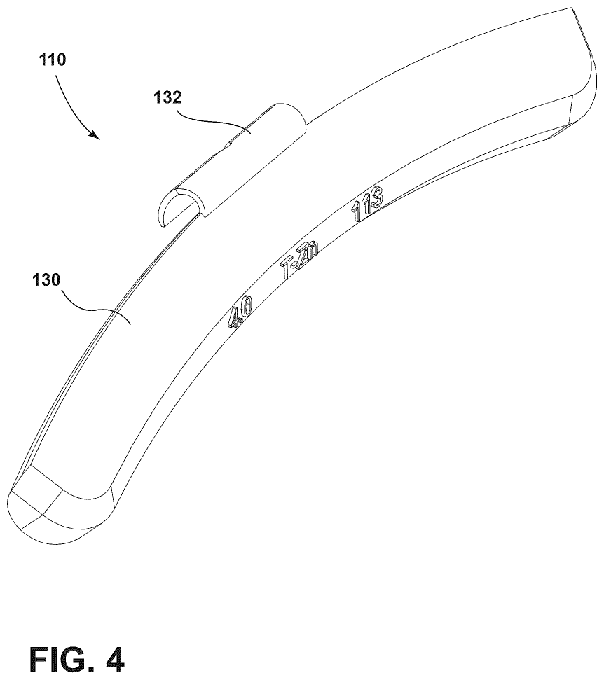

With reference to FIG. 4, an example wheel weight 110 is shown. The weight 110 may comprise one or more of a variety of shapes, sizes, configurations, and/or materials. In various implementations, the weight 110 includes a body 130 and a clip 132 coupled to the body 130. The size of the body 130 may vary depending on the amount of weight needed to balance the wheel 112. For example, a larger body 130 may have a greater amount of weight in comparison with a smaller body 130. Referring to FIG. 11, the weight 110 is shown removably coupled to a wheel 112. For example, the body 130 may engage an outer surface 140 of the wheel 112 and the clip 132 may be coupled to a rim 142 of the wheel 112.

### Wheel Weight Holder

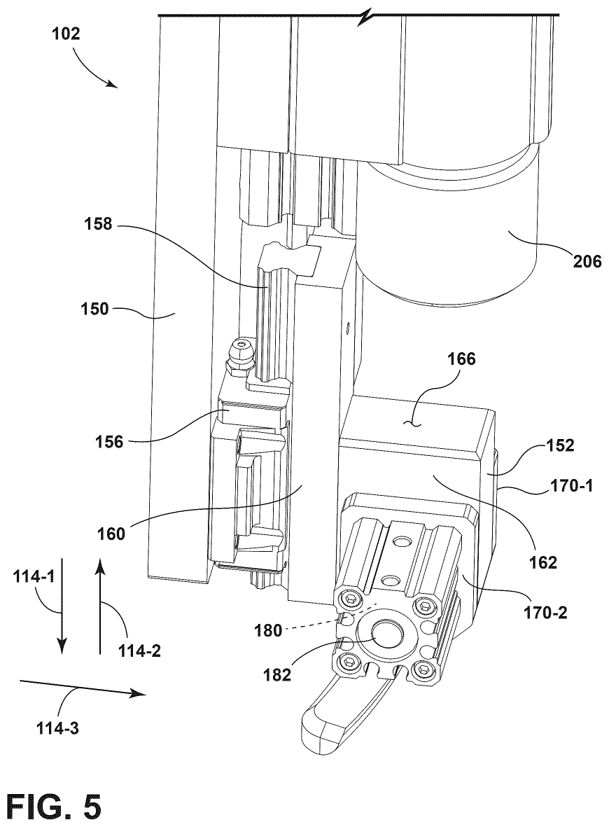

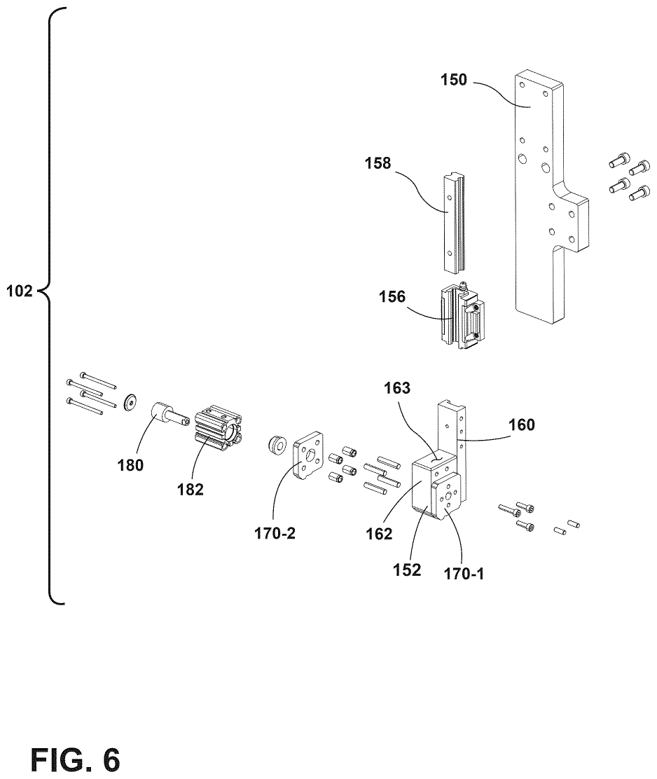

With reference to FIGS. 5-8, an example wheel weight holder 102 is shown. The holder 102 may comprise one or more of a variety of shapes, sizes, configurations, and/or materials. In various implementations, the holder 102 includes a base 150 and an applicator 152 translatably coupled to the base 150, among others. The applicator 152 may move, relative to base 150, in the first direction 114-1 or a second direction 114-2 opposite the first direction 114. For example, the holder 102 may include a track 156 coupled to the base 150 and a rail 158 coupled to the applicator 152. The rail 158 may be translatably coupled to the track 156 so that the applicator 152 can move relative to the base 150.

In various implementations, the applicator 152 includes a base portion 160 and a body 162 extending from the base portion 160. The body 162 may extend from the base portion 160 in a third direction 114-3 orthogonal to the first direction 114-1. The base portion 160 may be coupled to the rail 158. The body 162 may include an outer surface 166. In various implementations, the actuator 104 engages the outer surface 166 to move the applicator 152 relative to the base 150.

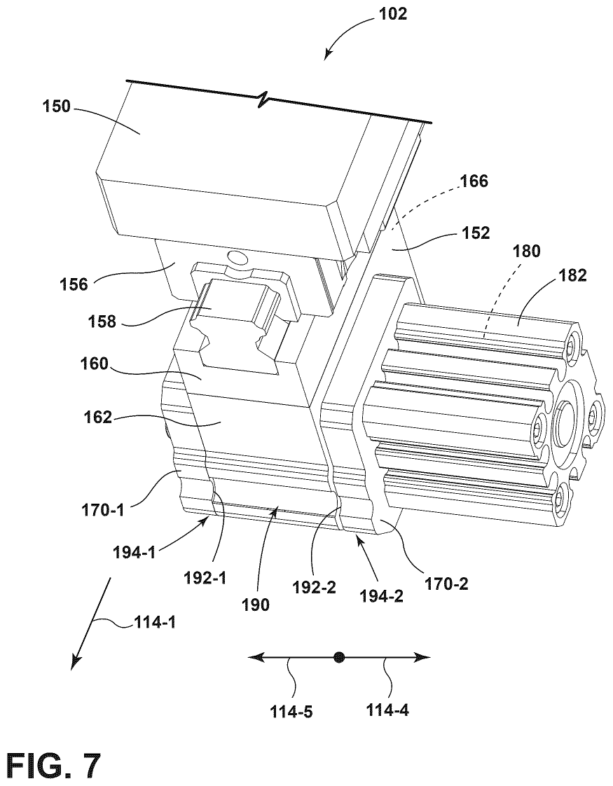

Referring now to FIG. 7, in various implementations, the applicator 152 includes a first plate 170-1 and a second plate 170-2 coupled to the body 162. At least one of the first and second plates 170-1, 170-2 may be translatably coupled to the body 162. In some example configurations, the first plate 170-1 is fixed to the body 162 and the second plate 170-2 may move relative to the body 162. The second plate 170-2 may move, relative to the body 162, in a fourth direction 114-4 orthogonal to the first direction 114-1 or a fifth direction 114-5 opposite the fourth direction 114-4. The movement of the second plate 170-2 may be driven by an actuator 180. The actuator 180 may be coupled to the first plate 170-1, the second plate 170-2, and/or the body 162.

In various implementations, the actuator 180 is enclosed by a housing 182. The housing 182 may be coupled to the second plate 170-2. The actuator 180 may be communicatively coupled to the controller 120. The controller 120 may control operation of the actuator 180. In some implementations, the actuator 180 is an air cylinder, but it will be appreciated that the actuator 180 may be a hydraulic actuator, a motor, a servomechanism, a solenoid, etc. within the scope of the present disclosure.

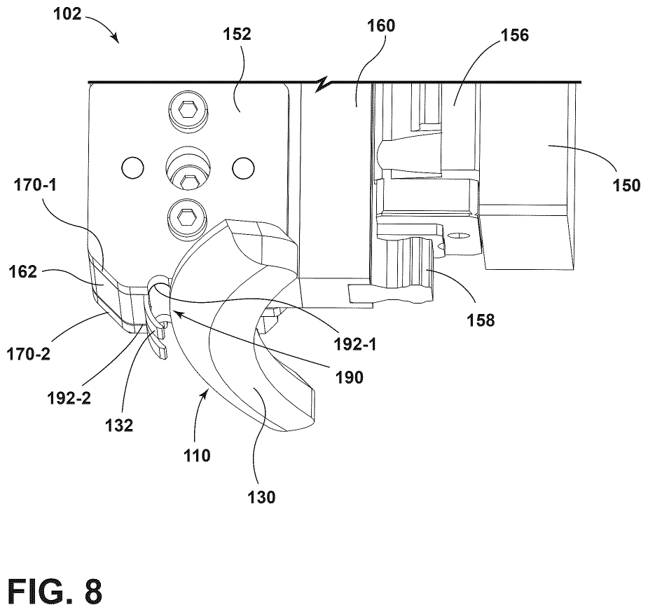

Referring now to FIGS. 7 and 8, the body 162 may define a recess 190 that receives a portion of a wheel weight 110 (e.g., a clip 132). The recess 190 may be disposed on an opposite side of the body 162 than the surface 166. In various implementations, the first plate 170-1 includes a first edge 192-1 and the second plate 170-2 includes a second edge 192-2. The first edge 192-1 may be disposed proximate a first end 194-1 of the recess 190 and the second edge 192-2 may be disposed a second end 194-2 of the recess 190 opposite the first end 194-1.

A wheel weight 110 may be releasably coupled to the applicator 152 via a friction fit connection. For example, when the wheel weight 110 is coupled to the applicator 152, a clip 132 of the weight 110 may be disposed in the recess 190 and may engage the first and second edges 192-1, 192-2. To accommodate varying sized weights 110, the second plate 170-2 may be moved, relative to the body 162, to increase or decrease the distance between the first and second edges 192-1, 192-2.

### Actuator

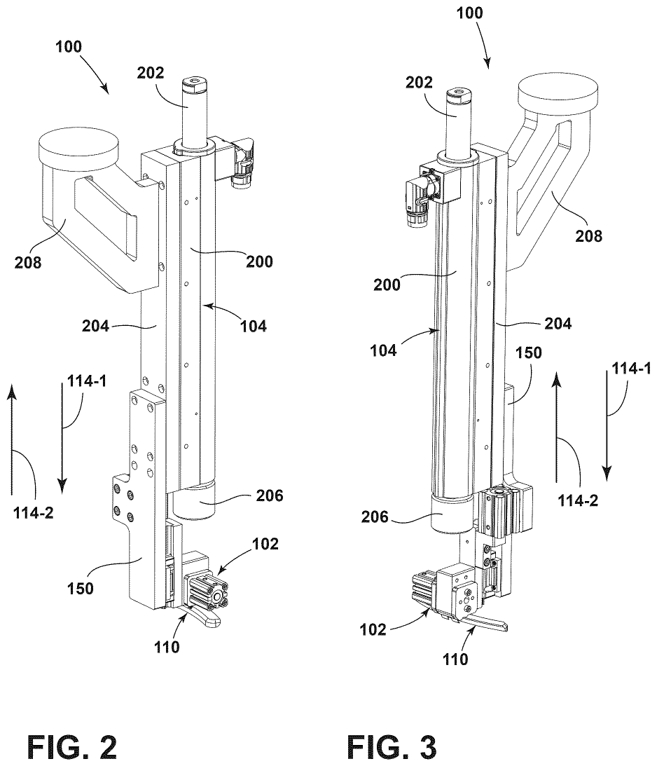

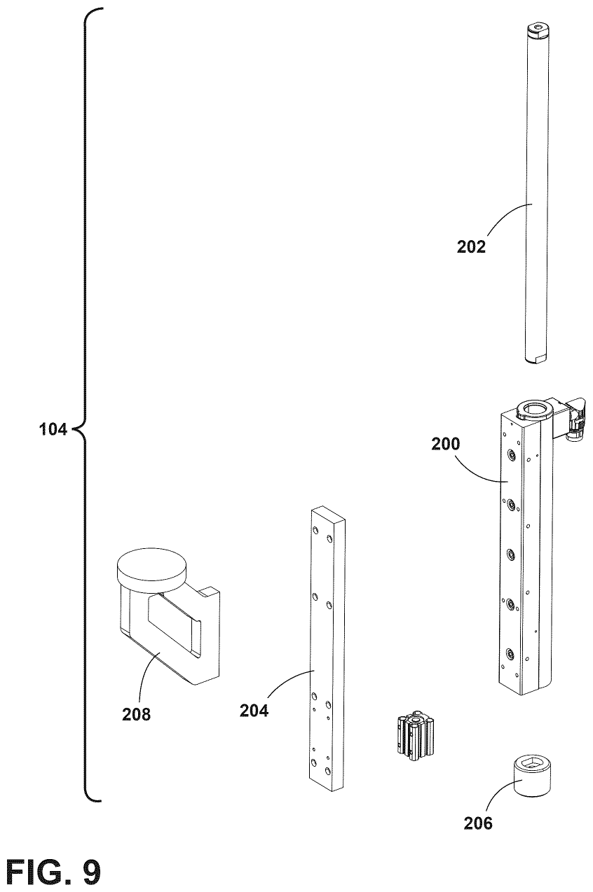

With reference to FIGS. 2, 3, and 9, an example actuator 104 (e.g., a hydraulic actuator, a pneumatic actuator, or an electric motor actuator, among others) is shown. The actuator 104 may comprise one or more of a variety of shapes, sizes, configurations, and/or materials. In various implementations, the actuator 104 includes a housing 200 and a rod 202, among others. At least a portion of the rod 202 may be disposed within the housing 200. In various implementations, the rod 202 moves relative to the housing 200 in the first direction 114-1 or the second direction 114-2. For example, movement of the rod 202 may be driven by pressurized fluid, compressed air, or an electric motor, among others.

In various implementations, the actuator 104 is coupled to the holder 102. For example, the actuator 104 may include a base plate 204 that is coupled to the housing 200 and the base 150 of the holder 102. The actuator 104 may be coupled to the arm 106 of the robot 108. For example, the actuator 104 may include a mount 208 that is coupled with the arm 106 and the base plate 204.

In various implementations, the actuator 104 may include a striking member 206 coupled to a distal end of the rod 202. The striking member 206 engages the applicator 152 of the holder 102, for example, when the rod 202 is moved in the first direction 114-1. The actuator 104 may be coupled to the holder 102 so that the striking member 206 is disposed adjacent to the surface 166 of the applicator 152 (see, e.g., FIG. 5). The actuator 104 may be communicatively coupled to the controller 120. The controller 120 may control movement of the rod 202 and the striking member 206.

### Operation of Assembly

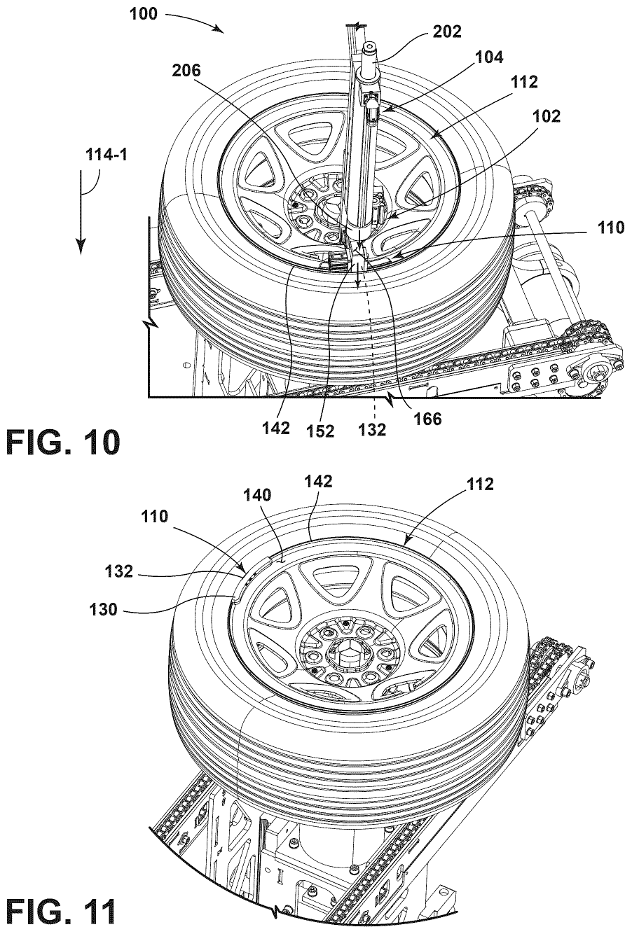

With reference to FIGS. 10 and 11, the assembly 100 couples a wheel weight 110 to a wheel 112. For example, the applicator 152 of the holder 102 may releasably hold the weight 110. In response to the actuator 104 being activated, the rod 202 moves in the first direction 114-1 so that the striking member 206 engages the applicator 152 (e.g., the surface 166 of the body 162). In response to the striking member 206 engaging the applicator 152, the striking member 206 moves the applicator 152 in the first direction 114-1 so that the clip 132 of the weight 110 couples to the rim 142 of the wheel 112. In response to the clip 132 being coupled to the rim 142 the weight 110 is coupled to the wheel 112 and the weight 110 is released from the applicator 152. In some instances, the weight 110 is released from the applicator 152 because the frictional force that couples the weight 110 to the applicator 152 is overcome when the clip 132 is coupled to the rim 142.

### Wheel Weight Applicator Assembly

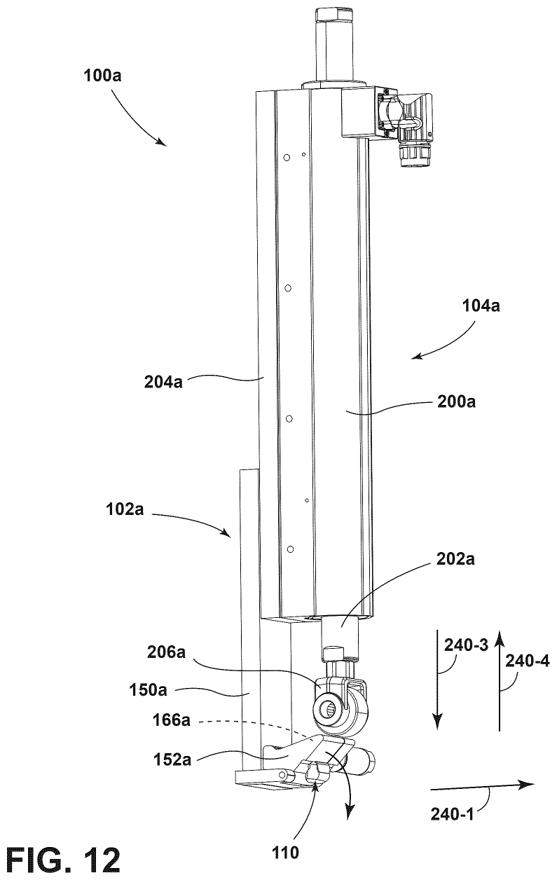

With reference to FIG. 12, an example wheel weight applicator assembly 100a is shown. In view of the similarity in structure and function of the assembly 100a to the assembly 100, like reference numerals are used hereinafter and in the drawings to identify like components while like reference numerals containing letter extensions (e.g., “a”) are used to identify those components that have been modified.

As will be explained in more detail below, the assembly 100a may include a wheel weight holder 102a and an actuator 104a, among others. The holder 102a may be coupled to the actuator 104a. The actuator 104a may be coupled to an arm 106 of a robot 108. A controller 120 may be communicatively coupled to the assembly 100a.

In various implementations, the holder 102a releasably holds a wheel weight 110. The arm 106 may move the assembly 100a so that the weight 110 is positioned adjacent a determined connection location of a wheel 112. When the actuator 104a is activated, the actuator 104 engages the holder 102a, causing the weight 110 to be rotated so that the weight 110 can be coupled to the wheel 112 at the connection location.

### Wheel Weight Holder

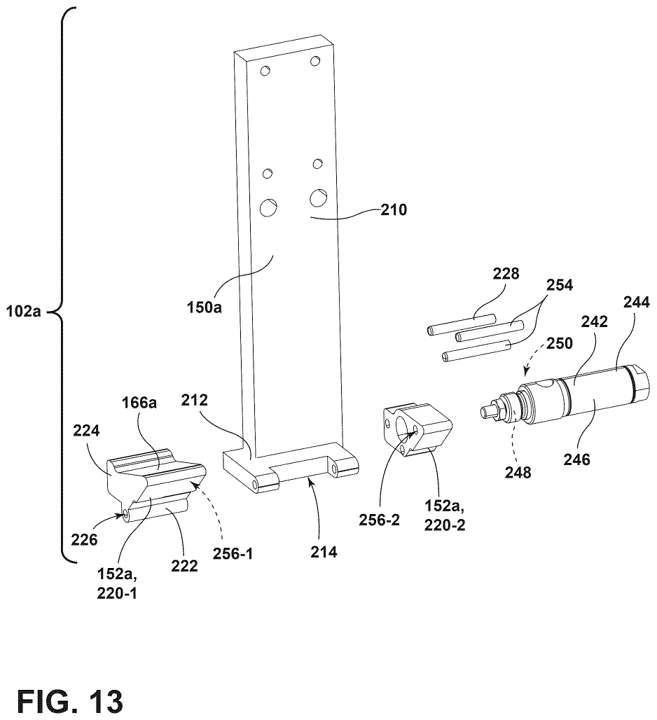

With reference to FIGS. 13-17, an example wheel weight holder 102a is shown. The holder 102a may comprise one or more of a variety of shapes, sizes, configurations, and/or materials. In various implementations, the holder 102a includes a base 150a and an applicator 152a rotatably coupled to the base 150a, among others.

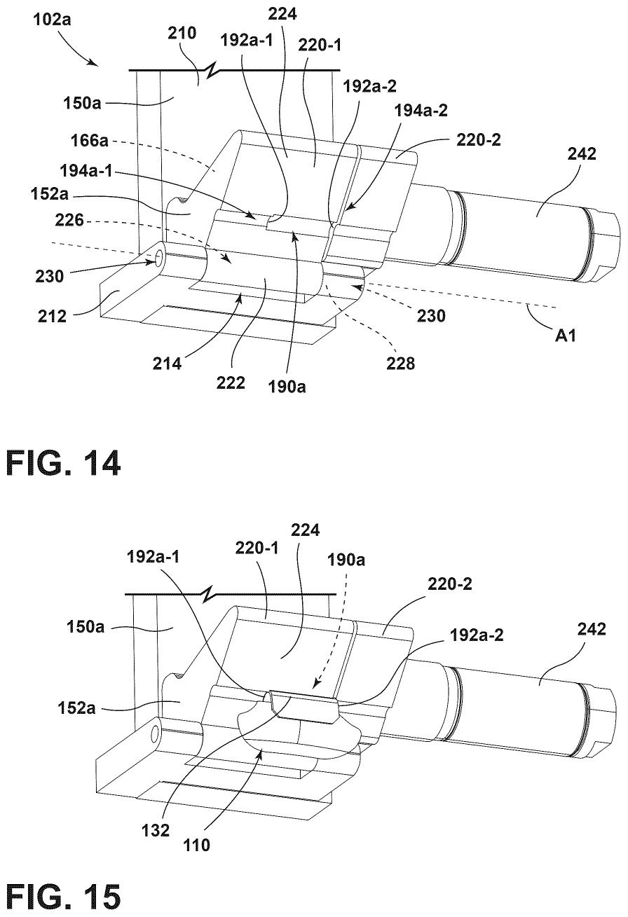

Referring now to FIGS. 13 and 14, in various implementations, the base 150a includes a first portion 210 and a second portion 212 extending from the first portion 210. The second portion 212 may define an opening 214 that receives a portion of the applicator 152a.

In various implementations, the applicator 152 includes a first piece 220-1 and a second piece 220-2 translatably coupled to the first piece 220-1. The first piece 220-1 may include a base portion 222 and a body 224 extending from the base portion 222. The base portion 222 may define a channel 226 that receives a pin 228. In an assembled configuration, the base portion 222 is disposed in the opening 214 and the pin 228 is disposed in the channel 226 and corresponding apertures 230 of the second portion 212 so that the applicator 152a can rotate relative to a first axis A1.

In various implementations, the body 224 includes an outer surface 166a. The actuator 104a may engage the outer surface 166a to rotate the applicator 152a relative to the base 150a about the pin 228 and the axis A1.

Referring now to FIGS. 13, 16, and 17, in various implementations, the second piece 220-2 moves relative to the first piece in a first direction 240-1 or a second direction 240-2 opposite the first direction 240-1. For example, the applicator 152a may include an actuator 242 that facilitates the movement of the second piece 220-2 relative to the first piece 220-1. The actuator 242 may include a housing 244, a rod 246 translatably disposed within the housing 244, and a seal 248 coupled to the rod 246, among others. The housing 244 may be coupled to the second piece 220-2. The rod 246 may be coupled to the first and second pieces 220-1, 220-2. The seal 248 may be disposed adjacent to a distal end 250 of the rod 246.

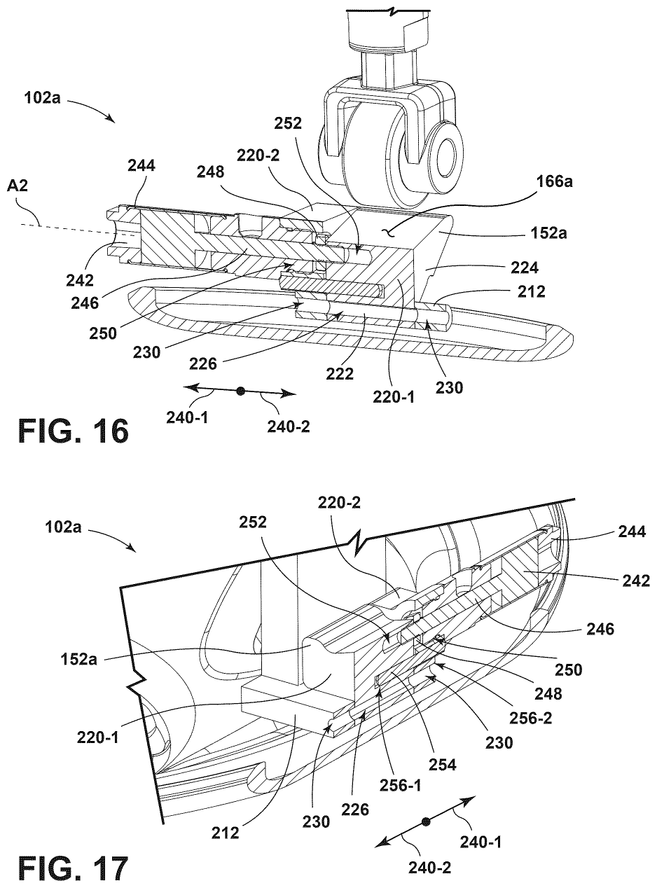

With reference to FIG. 16, in some implementations, the actuator 242 is an air cylinder. It will be appreciated, however, that the actuator 242 may be a hydraulic actuator, a motor, a servomechanism, a solenoid, etc. within the scope of the present disclosure. For example, the rod 246 may fluidly communicate with a cavity 252 formed in the applicator 152a to cause the second piece 220-2 to translate relative to the first piece 220-1 along a second axis A2 (e.g., in the first direction 240-1 and/or the second direction 240-2).

Referring again to FIGS. 13 and 17, in various implementations, the applicator 152a includes at least one additional pin 254. A pin 254 may be coupled to the first and second pieces 220-1, 220-2. For example, the pin 254 may be disposed in a first aperture 256-1 of the first piece 220-1 and a second aperture 256-2 of the second piece 220-2. The pin 254 may facilitate the alignment of the first and second pieces 220-1, 220-2, for example, while the second piece 220-1 is moved relative to the first piece 220-1.

Referring now to FIGS. 14 and 15, the first piece 220-1 may define a recess 190a that receives a portion of a wheel weight 110 (e.g., a clip 132). The recess 190a may be disposed on an opposite side of the body 224 than the surface 166a. In various implementations, the first piece 220-1 includes a first edge 192a-1 and the second piece 220-2 includes a second edge 192a-2. The first edge 192a-1 may be disposed proximate a first end 194a-1 of the recess 190a and the second edge 192a-2 may be disposed a second end 194a-2 of the recess 190a opposite the first end 194a-1.

A wheel weight 110 may be releasably coupled to the applicator 152a via a friction fit connection. For example, when the wheel weight 110 is coupled to the applicator 152a, a clip 132 of the weight 110 may be disposed in the recess 190a and may engage the first and second edges 192a-1, 192a-2. To accommodate varying sized weights 110, the second piece 220-2 may be moved, relative to the first piece 220-1, to increase or decrease the distance between the first and second edges 192a-1, 192a-2.

### Actuator

Referring again to FIG. 12, an example actuator 104a (e.g., a hydraulic actuator, a pneumatic actuator, or an electric motor actuator, among others) is shown. The actuator 104a may comprise one or more of a variety of shapes, sizes, configurations, and/or materials. In various implementations, the actuator 140a includes a housing 200a and a rod 202a, among others. At least a portion of the rod 202a may be disposed within the housing 200a. In various implementations, the rod 202a moves relative to the housing 200a in a third direction 240-3 (e.g., orthogonal to the first direction 240-1) or a fourth direction 240-3 opposite the third direction 240-3. For example, movement of the rod 202a may be driven by pressurized fluid, compressed air, or an electric motor, among others.

In various implementations, the actuator 104a is coupled to the holder 102a. For example, the actuator 104a may include a base plate 204a that is coupled to the housing 200a and the base 150a of the holder 102a.

In various implementations, the actuator 104a may include a roller 206a coupled to a distal end of the rod 202a. The roller 206a engages the applicator 152a of the holder 102a, for example, when the rod 202a is moved in the third direction 204-3. The actuator 104a may be coupled to the holder 102a so that the roller 206a is disposed adjacent to the surface 166a of the applicator 152a. The actuator 104a may be communicatively coupled to the controller 120. The controller 120 may control movement of the rod 202a and the roller 206a.

### Operation of Assembly

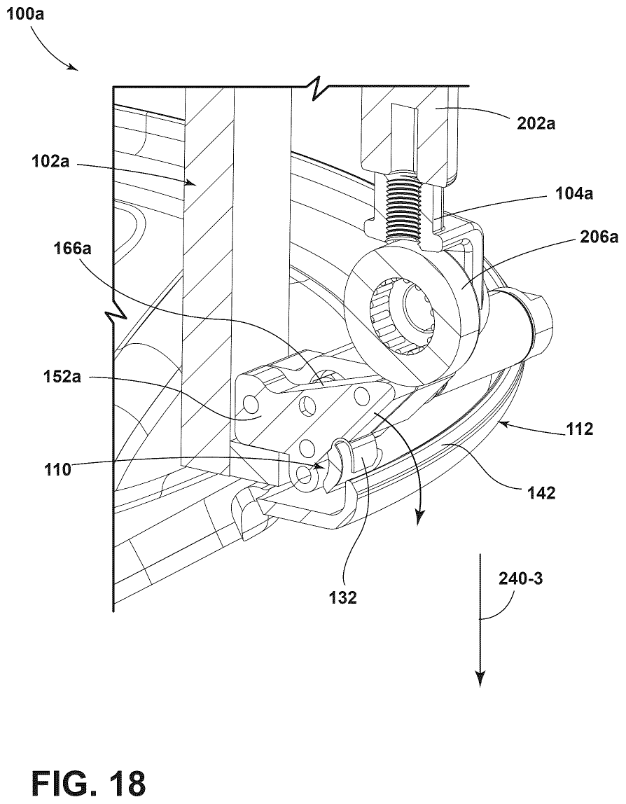

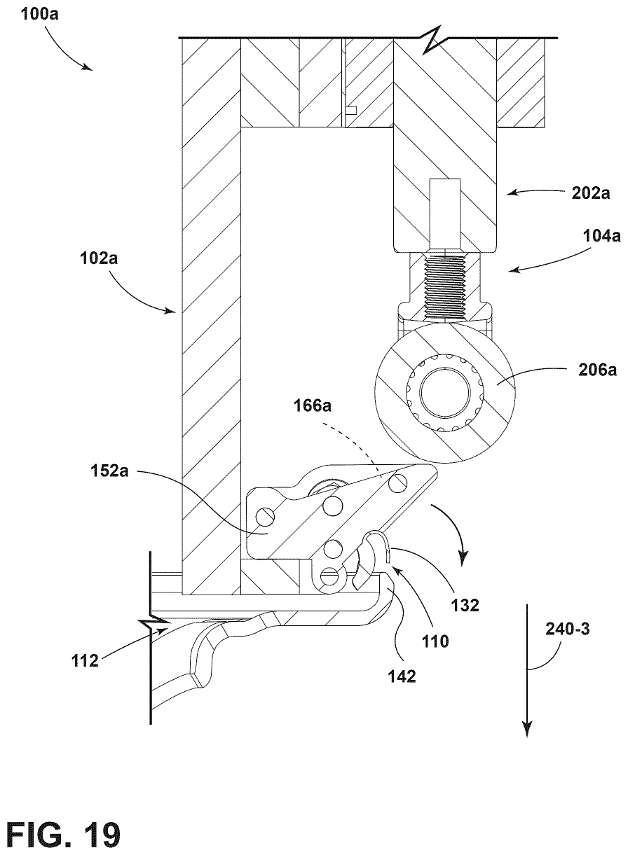

With reference to FIGS. 18 and 19, the assembly 100a couples a wheel weight 110 to a wheel 112. For example, the applicator 152a of the holder 102a may releasably hold the weight 110. In response to the actuator 104a being activated, the rod 202a moves in the third direction 240-3 so that the roller 206a engages the applicator 152a (e.g., the surface 166a). In response to the roller 206a engaging the applicator 152a, the roller 206a rotates the applicator 152a (e.g., in a clockwise direction) so that the clip 132 of the weight 110 couples to the rim 142 of the wheel 112. In response to the clip 132 being coupled to the rim 142, the weight 110 is coupled to the wheel 112 and the weight 110 is released from the applicator 152a. In some instances, the weight 110 is released from the applicator 152a because the frictional force that couples the weight 110 to the applicator 152a is overcome when the clip 132 is coupled to the rim 142.

### Wheel Weight Applicator

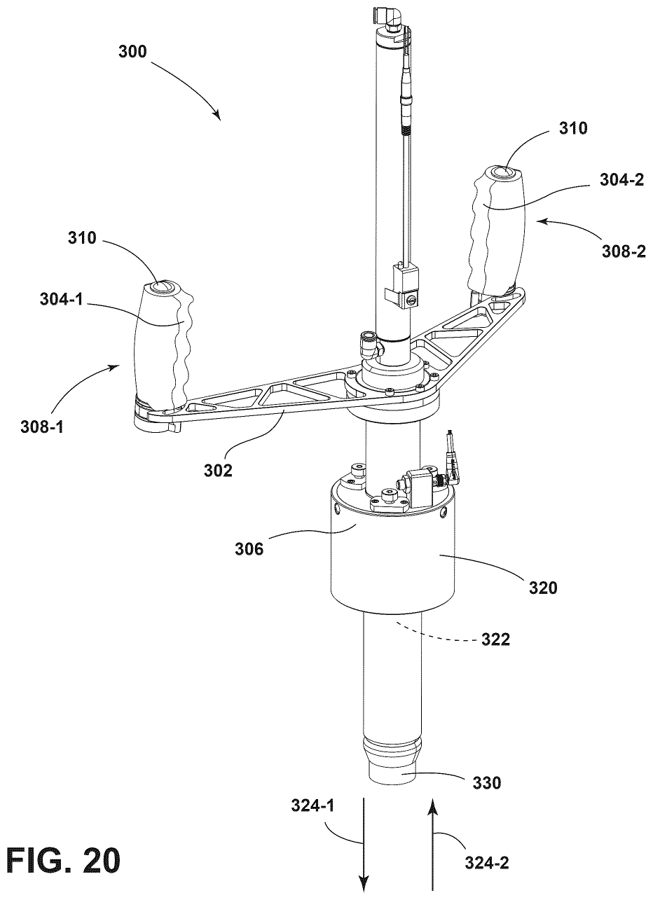

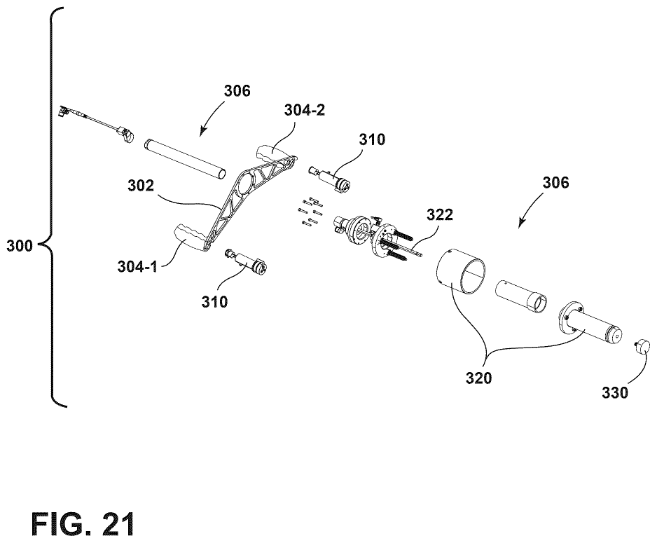

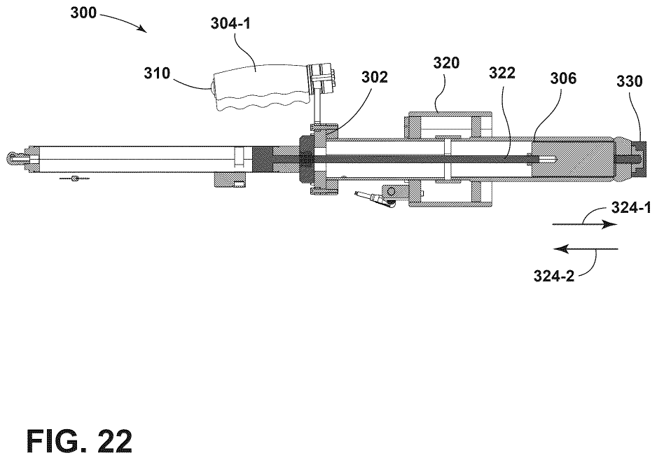

With reference to FIGS. 20-22, an example wheel weight applicator 300 is shown. The applicator 300 may be used to manually couple wheel weights 110 to wheels 112. The applicator 300 may comprise one or more of a variety of shapes, sizes, configurations, and/or materials. In various implementations, the applicator 300 includes a bracket 302, a first handle 304-1, a second handle 304-2, and an actuator 306, among others.

In various implementations, the first and second handles 304-1, 304-2 are coupled to the bracket 302. For example, the first handle 304-1 may be coupled to a first end 308-1 of the bracket 302 and the second handle 304-2 may be coupled to a second end 308-2 of the bracket 302 opposite the first end 308-1. The actuator 306 may be coupled to the bracket 302. The actuator 306 may be disposed between the first and second handles 304-1, 304-2.

In various implementations, each of the first and second handles 304-1, 304-2 includes a sensor 310. At least a portion of a sensor 310 may be disposed within a handle 304-1, 304-2. A sensor 310 may detect the presence of a user's hand (e.g., operator of the applicator 300) on a handle 304-1, 304-2. For example, a sensor 310 may detect whether the user is griping a handle 304-1, 304-2. A sensor 310 may be a capacitive sensor, an infrared sensor, a piezoelectric sensor, a force sensor, an optical sensor, an ultrasonic sensor, an inductive sensor, a resistive touch sensor, a temperature sensor, or a pressure sensor, among others. Each of the sensors 310 may be communicatively coupled to the actuator 306 and/or a controller (not shown).

In various implementations, the actuator 306 (e.g., a hydraulic actuator, a pneumatic actuator, or an electric motor actuator, among others) includes a housing 320 and a rod 322. At least a portion of the rod 332 may be disposed within the housing 320. In various implementations, the rod 322 moves relative to the housing 320 in a first direction 324-1 or a second direction 324-2 opposite the first direction 324-1. For example, movement of the rod 322 may be driven by pressurized fluid, compressed air, or an electric motor, among others. The actuator 306 may by communicatively coupled to a controller (not shown). The controller may control the movement of the rod 322.

In various implementations, the actuator 306 may include a striking member 330 coupled, at least indirectly, to a distal end of the rod 322. The striking member 330 may engage and force a wheel weight 110 to attach to a rim 142 of a wheel 112.

During operation of the applicator 300, the sensors 310 detect whether a user is gripping each of the first and second handles 304-1, 304-2. In response to the sensors 310 detecting the presence of the user's hands on the first and second handles 304-1, 304-2, the actuator 306 may be activated. In response to the actuator 304 being activated, the striking member 330 may move in the first direction 324-1 to force a weight wheel 110 to attach to a rim 142 of a wheel 112.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

Various example embodiments of the invention are described in the following clauses.

Clause 1: A wheel weight applicator assembly comprising: a base; a striking member translatably coupled to the base; and a wheel weight holder translatably coupled to the base and configured to releasably hold a wheel weight, wherein the wheel weight holder is configured to translate relative to the base and the striking member upon engagement of the striking member with the wheel weight holder.

Clause 2: The wheel weight applicator assembly of clause 1 wherein the holder is configured to releasably hold the weight via a friction fit connection.

Clause 3: The wheel weight applicator assembly of any of clauses 1 or 2 wherein the holder is configured to release the weight when a frictional force that couples the weight to the holder is overcome.

Clause 4: The wheel weight applicator assembly of any of clauses 1 through 3 further comprising an actuator coupled to the base and configured to move the striking member.

Clause 5: The wheel weight applicator assembly of clause 4 wherein the actuator is coupled to a robot.

Clause 6: A wheel weight holder comprising: a base; and an applicator translatably coupled to the base, wherein the applicator is configured to (i) releasably hold a wheel weight and (ii) couple the weight to a wheel when the applicator is moved relative to the base.

Clause 7: The wheel weight holder of clause 6 wherein the applicator includes: a track coupled to the base; and a rail coupled to the applicator and translatably coupled to the track.

Clause 8: The wheel weight holder of any of clauses 6 or 7 wherein the applicator includes: a base portion; and a body extending from the base portion and defining a recess configured to receive a portion of the weight.

Clause 9: The wheel weight holder of clause 8 wherein the applicator includes: a first plate coupled to the body and defining a first edge; and a second plate translatably coupled to the body and defining a second edge.

Clause 10: The wheel weight holder of clause 9 wherein the weight engages the first edge and the second edge when the portion of the weight is disposed in the recess.

Clause 11: A wheel weight applicator assembly comprising: a base; a striking member translatably coupled to the base; and a wheel weight holder rotatably coupled to the base and configured to releasably hold a wheel weight, wherein the wheel weight holder is configured to rotate relative to the base and the striking member upon engagement of the striking member with the wheel weight holder.

Clause 12: The wheel weight applicator assembly of clause 11 wherein the holder is configured to releasably hold the weight via a friction fit connection.

Clause 13: The wheel weight applicator assembly of any of clauses 11 or 12 wherein the holder is configured to release the weight when a frictional force that couples the weight to the holder is overcome.

Clause 14: The wheel weight applicator assembly of any of clauses 11 through 13 further comprising an actuator coupled to the base and configured to move the striking member, wherein the striking member includes a roller configured to engage the holder and rotate the holder relative to the base.

Clause 15: A wheel weight holder comprising: a base; and an applicator rotatably coupled to the base and configured to (i) releasably hold a wheel weight and (ii) couple the wheel weight to a wheel when the applicator is rotated relative to the base.

Clause 16: The wheel weight holder of clause 15 wherein the applicator includes a first piece and a second piece translatably coupled to the first piece.

Clause 17: The wheel weight holder of clause 16 wherein the first piece defines a recess configured to receive a portion of the weight.

Clause 18: The wheel weight holder of clause 17 wherein: the first piece includes a first edge, and the second piece includes a second edge.

Clause 19: The wheel weight holder of clause 18 wherein the weight engages the first edge and the second edge when the portion of the weight is disposed in the recess.

Clause 20: A wheel weight applicator comprising: a bracket; a first handle coupled to the bracket and including a first sensor; a second handle coupled to the bracket and including a second sensor; and an actuator coupled to the bracket and disposed between the first and second handles, wherein the actuator is configured to be activated when the first and second sensors detect user hands on the first and second handles.

1. A wheel weight applicator assembly comprising:
a base;
a striking member translatably coupled to the base; and
a wheel weight holder translatably coupled to the base and configured to releasably hold a wheel weight, wherein the wheel weight holder is configured to translate relative to the base and the striking member upon engagement of the striking member with the wheel weight holder.

2. The wheel weight applicator assembly of claim 1 wherein the holder is configured to releasably hold the weight via a friction fit connection.

3. The wheel weight applicator assembly of claim 1 wherein the holder is configured to release the weight when a frictional force that couples the weight to the holder is overcome.

4. The wheel weight applicator assembly of claim 1 further comprising an actuator coupled to the base and configured to move the striking member.

5. The wheel weight applicator assembly of claim 4 wherein the actuator is coupled to a robot.

6. A wheel weight holder comprising:
a base; and
an applicator translatably coupled to the base,
wherein the applicator is configured to (i) releasably hold a wheel weight and (ii) couple the weight to a wheel when the applicator is moved relative to the base.

7. The wheel weight holder of claim 6 wherein the applicator includes:
a track coupled to the base; and
a rail coupled to the applicator and translatably coupled to the track.

8. The wheel weight holder of claim 6 wherein the applicator includes:
a base portion; and
a body extending from the base portion and defining a recess configured to receive a portion of the weight.

9. The wheel weight holder of claim 8 wherein the applicator includes:
a first plate coupled to the body and defining a first edge; and
a second plate translatably coupled to the body and defining a second edge.

10. The wheel weight holder of claim 9 wherein the weight engages the first edge and the second edge when the portion of the weight is disposed in the recess.

11. A wheel weight applicator assembly comprising:
a base;
a striking member translatably coupled to the base; and
a wheel weight holder rotatably coupled to the base and configured to releasably hold a wheel weight, wherein the wheel weight holder is configured to rotate relative to the base and the striking member upon engagement of the striking member with the wheel weight holder.

12. The wheel weight applicator assembly of claim 11 wherein the holder is configured to releasably hold the weight via a friction fit connection.

13. The wheel weight applicator assembly of claim 11 wherein the holder is configured to release the weight when a frictional force that couples the weight to the holder is overcome.

14. The wheel weight applicator assembly of claim 11 further comprising an actuator coupled to the base and configured to move the striking member, wherein the striking member includes a roller configured to engage the holder and rotate the holder relative to the base.

15. A wheel weight holder comprising:
a base; and
an applicator rotatably coupled to the base and configured to (i) releasably hold a wheel weight and (ii) couple the wheel weight to a wheel when the applicator is rotated relative to the base.

16. The wheel weight holder of claim 15 wherein the applicator includes a first piece and a second piece translatably coupled to the first piece.

17. The wheel weight holder of claim 16 wherein the first piece defines a recess configured to receive a portion of the weight.

18. The wheel weight holder of claim 17 wherein:
the first piece includes a first edge, and
the second piece includes a second edge.

19. The wheel weight holder of claim 18 wherein the weight engages the first edge and the second edge when the portion of the weight is disposed in the recess.

20. A wheel weight applicator comprising:
a bracket;
a first handle coupled to the bracket and including a first sensor;
a second handle coupled to the bracket and including a second sensor; and
an actuator coupled to the bracket and disposed between the first and second handles,
wherein the actuator is configured to be activated when the first and second sensors detect user hands on the first and second handles.
